(19) United States
(12) Patent Application Publication
(10) Pub. No.: US 2023/0216579 A1
(43) Pub. Date: Jul. 6, 2023

(54) COMMUNICATION IN NON-TERRESTRIAL NETWORKS

(71) Applicant: Nokia Technologies Oy, Espoo (FI)

(72) Inventors: Kim NIELSEN, Storvorde (DK); István Zsolt KOVÁCS, Aalborg (DK); Rafhael MEDEIROS DE AMORIM, Aalborg (DK)

(21) Appl. No.: 18/002,905

(22) PCT Filed: Feb. 26, 2021
(86) PCT No.: PCT/FI2021/050142

§ 371 Date: Dec. 22, 2022

(30) Foreign Application Priority Data
Jul. 3, 2020 (FI) 20205710

(51) Int. Cl. H04B 7/185; H04W 24/08

(52) U.S. Cl. CPC H04B 7/18539; H04W 24/08; H04W 84/06

(57) ABSTRACT

Apparatuses and methods for communication in non-terrestrial networks are provided. Downlink transmission from a satellite node is received (300). Pathloss of uplink transmission to the satellite node is estimated (302). Based on the path loss, it is determined (304) whether uplink transmission of the apparatus can reach the satellite node and uplink transmission suspended (306) if determination indicates that the transmission will not reach the node.

### FIELD

The exemplary and non-limiting embodiments of the invention relate generally to wireless communication systems. Embodiments of the invention relate especially to apparatuses and methods in wireless communication networks.

### BACKGROUND

Wireless communication systems are under constant development.

In additional to traditional cellular communication, non-terrestrial networks may be utilised in communication especially where coverage of land-based access nodes is poor. Designing communication utilising both cellular and non-terrestrial networks is challenging due to different propagation environments.

3GPP TR 38.821 V1.1.0 (2019-12) Solutions for NR to support non-terrestrial networks (NTN) (Release 16) discusses communication utilising non-terrestrial networks.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description that is presented later.

According to an aspect of the present invention, there is provided an apparatus of claim 1.

According to an aspect of the present invention, there is provided a method of claim 8.

According to an aspect of the present invention, there is provided a computer program comprising instructions of claim 15.

One or more examples of implementations are set forth in more detail in the accompanying drawings and the description below. Other features will be apparent from the description and drawings, and from the claims. The embodiments and/or examples and features, if any, described in this specification that do not fall under the scope of the independent claims are to be interpreted as examples useful for understanding various embodiments of the invention.

### LIST OF DRAWINGS

Embodiments of the present invention are described below, by way of example only, with reference to the accompanying drawings, in which

FIG. 1 illustrates an example of simplified system architecture of a communication system;

FIG. 2 illustrates an example of pathloss at 2 GHz satellite node transmission;

FIG. 3 is a flowchart illustrating an embodiment;

FIG. 4 illustrates an example of pathloss in satellite node transmission;

FIGS. 5, 6, 7, 8, and 9 are flowcharts illustrating embodiments;

FIGS. 10 and 11 illustrate examples of pathloss at 2 GHz satellite node transmission; and

FIG. 12 illustrates an example of an apparatus.

### DESCRIPTION OF SOME EMBODIMENTS

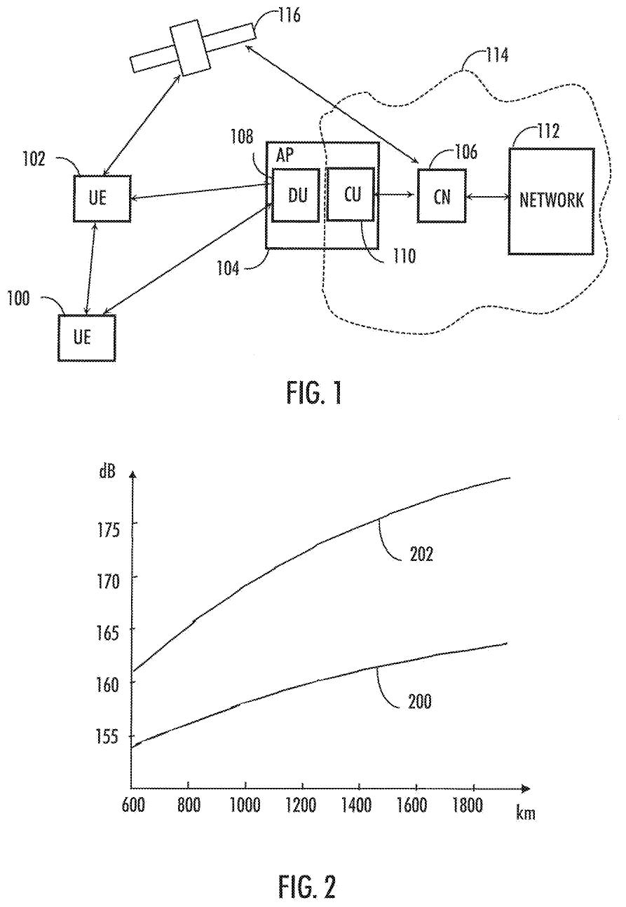

FIG. 1 shows devices 100 and 102. The devices 100 and 102 may, for example, be user devices or user terminals. The devices 100 and 102 are configured to be in a wireless connection on one or more communication channels with a node 104. The node 104 is further connected to a core network 106. In one example, the node 104 may be an access node, such as (e/g)NodeB, serving devices in a cell. In one example, the node 104 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 106 (CN or next generation core NGC). Depending on the system, the counterpart on the CN side can be a serving gateway (S-GW, routing and forwarding user data packets), packet data network gateway (P-GW), for providing connectivity of devices (UEs) to external packet data networks, or mobile management entity (MME), etc.

The device (also called a subscriber unit, user device, user equipment (UE), user terminal, terminal device, etc.) illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station.

The device typically refers to a device (e.g. a portable or non-portable computing device) that includes wireless mobile communication devices operating with or without an universal subscriber identification module (USIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz— cmWave, 6 or above 24 GHz— cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing. The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 108) and non-real time functions being carried out in a centralized manner (in a centralized unit, CU 110). It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication 116 to enhance or complement the coverage of 5G service, for example by providing backhauling. Possible use cases are providing service continuity for machine-to-machine (M2M) or Internet of Things (I) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

In communication involving connections between a terminal device and a satellite node the extreme operating link loss is one of the challenging aspects compared to terrestrial networks where terminal devices communicate with relatively near-by RAN nodes. In NR, it has been proposed that at least some terminal devices may communicate with satellites which may be either Low-Earth Orbit (LEO) or Geosynchronous Equatorial Orbit (GEO) satellites utilising FR1 frequency range. In NR, there are terminal devices of different power classes. The present solutions are applicable for terminal devices of power class 3, for example.

Terminal devices are typically battery powered devices. Thus, in many situations they have a limited power supply at their use. Therefore, power saving of terminal devices is an important goal in network design. When communicating with a satellite node, the terminal devices may be forced to transmit at high power due to the length of the transmission link and high pathloss. In terrestrial networks long transmission links may be generally avoided by placing RAN nodes in suitable distances from each other. In satellite communication this is not possible because of the high altitude of the satellites.

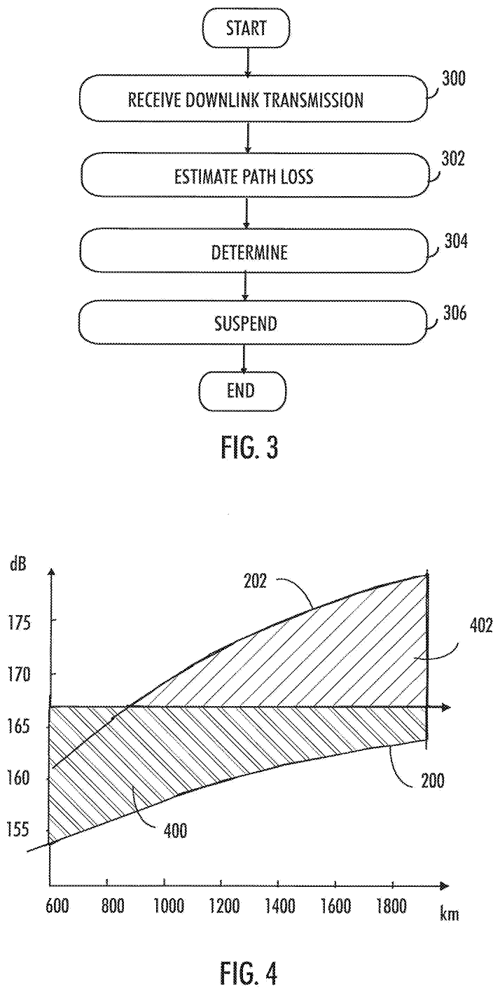

FIG. 2 illustrates an example of pathloss at 2 GHz transmission frequency on x-axis is distance in kilometres between a terminal device and a satellite node at 600 km altitude and on y-axis is the pathloss in dB, from nadir to 10° elevation angle. Satellite node antenna gain and terminal device antenna gain are not considered in the example of FIG. 2. The curve 200 illustrates an example of free space path loss as a function of distance. The curve 202 illustrates an example of path loss when effects occurring on the transmission path have been taken into account. These effects, some depending on the distance, comprise atmospheric absorption, scintillation, and rain, for example, increase the pathloss. The curves represent how earth fixed beams would be created and maintained by LEO passing satellites. The earth fixed cells will have a higher difference in distance to the terminal device, which for the ideal case may cause 10 dB of difference in pathloss.

In communication involving connections between a terminal device and a satellite node there may be situations where the pathloss is too great for the terminal transmitter. Even if transmitting at full power, the terminal transmission might not reach the satellite node. In such cases the terminal wastes power when trying to transmit to the satellite node.

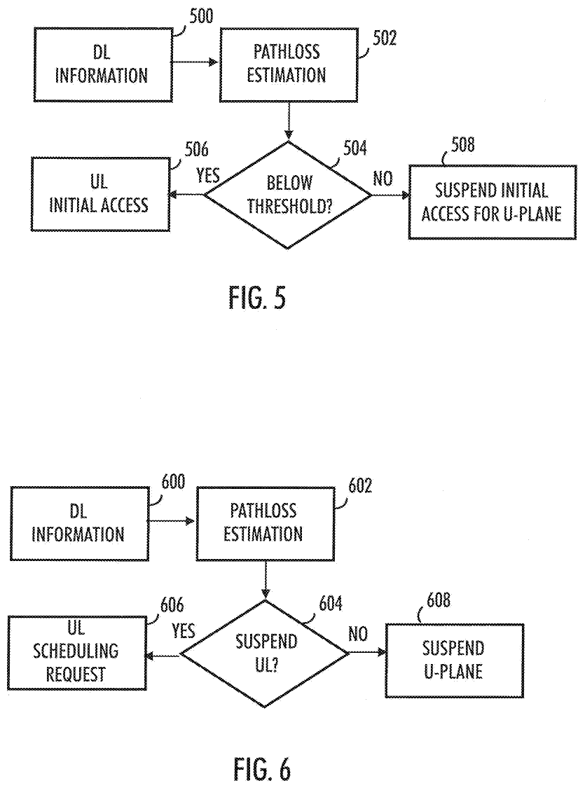

The flowchart of FIG. 3 illustrates an embodiment. The flowchart illustrates an example of the operation of an apparatus. In an embodiment, the apparatus may be a terminal device, user equipment, a part of a terminal device or any other apparatus capable of executing following steps.

In step 300, the apparatus is configured to receive downlink transmission from a satellite node.

In step 302, the apparatus is configured to estimate pathloss of uplink transmission to the satellite node.

In step 304, the apparatus is configured to determine based on the path loss whether uplink transmission of the apparatus can reach the satellite node.

In step 306, the apparatus is configured to suspend uplink transmission if determination indicates that the transmission will not reach the node. In an embodiment, the apparatus configured to suspend user-plane uplink transmission but allow control-plane uplink transmission.

In an embodiment, the terminal device is configured to evaluate whether the device has the signal strength to reach the satellite node or if it should schedule uplink transmission in a more advantageous way to save battery or power on wasted uplink data. The F1 frequency of 2 GHz is used below as example, but the proposed applies to all frequency ranges.

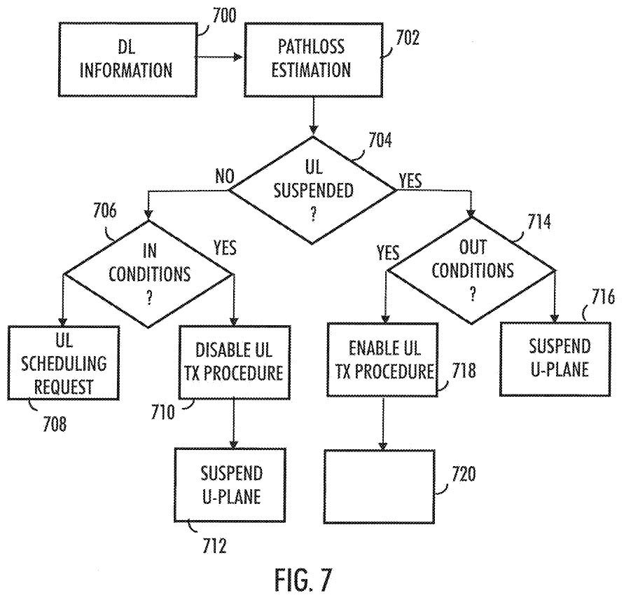

FIG. 4 illustrates an embodiment. As in FIG. 2, on x-axis is distance in kilometres between a terminal device and a satellite node at 600 km altitude and on y-axis is the pathloss in dB, from nadir (90° elevation angle) to 10° elevation angle. Thus, the figure illustrates passing of the satellite node over a ground based terminal device.

Assuming the antennas of the device and the satellite node provide a margin as shown in the hatched area 400, the device will cope with full uplink/downlink operation throughout the passing of the satellite. This happens for example if the pathloss follows the curve 200.

The hatched area 402 illustrates the area falling outside the uplink transmission capability of the terminal device. If the link degrades from the area 400 to area 402, the uplink transmission of the terminal device does not necessarily reach the satellite node. For example, assuming the pathloss of curve 202, the terminal device could reach the satellite node only up to 880 km distance. In an embodiment, the terminal device may estimate the pathloss and suspend its initial access procedure, or its uplink scheduling requests until it can safely reach the satellite. This helps the terminal device to save power and avoid unnecessary interference caused by the device transmitting what is now only noise at the device maximum output power level.

We may differentiate here two kinds of communication types between the terminal device and the satellite node, namely initial access procedure and connected mode, where uplink scheduling of user plane, U-plane, is performed. The differentiation between the initial access procedure and the uplink scheduling of U-plane can be expressed as the output power differences between control plane transmission and data transmission of different payloads.

For initial access, the uplink terminal device may follow standard idle mode schemes. In addition, it may use information of signal strength of the signal received from the satellite node to determine the link-loss at the given distance of the satellite node, for which the device may schedule further idle-mode counters, in case initial access is required when the satellite node is within reach of control plane, C-plane, uplink transmission capabilities

Regarding connected mode, even if U-plane uplink traffic is not requested by the uplink, the C-plane uplink signalling still needs to reach the satellite node for the connection not to be declared as failed. The hatched zone 400 in the example of FIG. 4 indicates the maximum operating range of the uplink C-plane. This means that the operating range of the uplink U-plane needs to be considered even smaller. Transmissions on the C-plane typically use the lowest coding and modulation scheme, which allows the transmission to happen without maximum output power back-off. However, as the U-plane transmission uses higher coding schemes, more bandwidth and higher order of modulation the maximum output power is backed off to comply with linearity requirements. This cuts down the range of the transmission on the U-plane.

Consider a case where a terminal device is communicating with a LEO satellite node and tries to perform a handover to a next satellite node when the current satellite node moves beyond reach. In case the handover fails, the terminal device may evaluate initial access procedures when required and, to save power and decrease interference, it may suspend its uplink C-plane transmission to the satellite until it has estimated that the uplink transmission may reach the satellite node.

In an embodiment, determination whether uplink transmission of the apparatus can reach the satellite node based at least partly on the estimation of link loss between the terminal device and the satellite node. The link loss estimation in turn can be based at least in part to some of the following:
Antenna gain of the terminal device (both transmit and receiving side)
Uplink power class of the terminal device (e.g. power class 3, 23 dBm)
Known or predictable distance between the terminal device and the satellite node. The distance may be determined from ephemeris data, for example. The distance does not need to be a high-resolution figure.
Transmission downlink power of the satellite node. It may be decoded from Synchronization Signal Block transmitted by the satellite node, as an integer (−60 dBm . . . +50 dBm) in combination with the measured received downlink power of satellite node transmission, as an estimation of the overall coupling losses.
Frequency offset between downlink and uplink frequencies.

In an embodiment, uplink link degradation may be detected from consecutive low uplink Modulation and Coding Scheme, MCS, scheduling.

In an embodiment, low downlink Modulation and Coding Scheme indicates downlink link degradation, thus with high probability also uplink link will experience degradation.

In an embodiment, received uplink fast power control command adjustments may be monitored. Consecutive commands for maximum transmit power indicates degraded uplink link-budget.

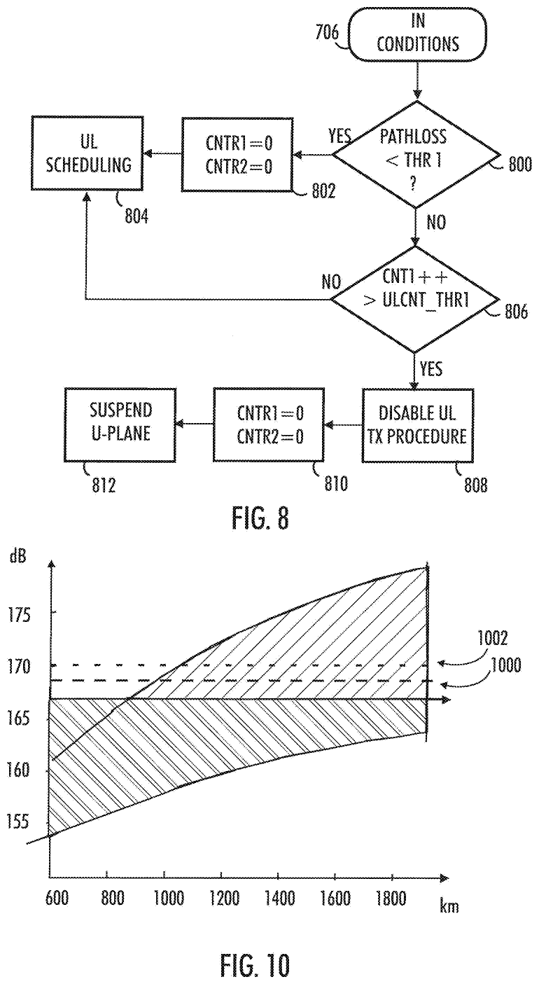

When performing initial access, a terminal device follows system process of initial access, which in case of NR means to respond to the broadcast channel containing the Synchronization Signal Block, SSB, transmitted by the satellite node. When the terminal device has been in Idle mode it may take advantage of the knowledge of the satellite distance and the link quality estimation as the satellite emerges at low elevation angles. The terminal device may then choose to suspend its transmission, even enter/re-enter idle mode if the satellite is afar, and the link-loss makes transmission impossible to reach the satellite. Once the terminal device engages initial access and establishes connection it proceeds to normal operation. An example of this procedure is illustrated in FIG. 5.

In step 500, the terminal device receives downlink transmission from a satellite node.

In step 502, the terminal device is configured to estimate pathloss of uplink transmission to the satellite node. In an embodiment, the estimation can be based at least in part on issues described above.

In step 504, the terminal device is configured to compare the estimated pathloss to a predetermined threshold.

If the pathloss is below the given threshold, the terminal is configured to perform 506 uplink initials access. If not, the terminal is configured to suspend 508 initial access for user plane.

During normal downlink/uplink operation, a terminal device will use regular reception and transmission time slots according to the system protocol, such as NR protocol. When the terminal device receives data from an emerging satellite in the horizon it begins evaluating the link quality with the satellite. After getting the path loss estimation it must determine if suspending uplink operation would be necessary, and if so, enter a state at which it remains with user plane suspended, while awaiting a transmission opportunity that satisfies a threshold which defines the link quality estimate. Eventually the device may schedule on its own to enter and exit conditions for the user plane suspension, for each passing satellite. An example of this procedure is illustrated in FIG. 6.

In step 600, the terminal device receives downlink transmission from a satellite node.

In step 602, the terminal device is configured to estimate pathloss of uplink transmission to the satellite node. In an embodiment, the estimation can be based at least in part on issues described above.

In step 604, the terminal device is configured to evaluate whether uplink U-plane is to be suspended.

If U-plane is not to be suspended, the terminal is configured to perform 606 uplink scheduling to obtain uplink transmission resources. If not, the terminal is configured to suspend 608 user plane transmission.

In an embodiment, the above processes may be further refined by adding margins, timers or threshold management. Flowcharts in FIGS. 7, 8 and 9 illustrate examples.

FIG. 7 illustrates an example of the overall procedure and FIGS. 8 and 9 illustrate two tests performed in the procedure.

Starting from the FIG. 7, in step 700, the terminal device receives downlink transmission from a satellite node.

In step 702, the terminal device is configured to estimate pathloss of uplink transmission to the satellite node. In an embodiment, the estimation can be based at least in part on issues described above.

In step 704, the terminal device is configured to determine whether uplink transmission on U-plane is currently suspended on not.

If uplink transmission on U-plane is currently not suspended, so-called IN- conditions are tested in step 706. This is described in more detail in FIG. 8.

If IN-conditions are not fulfilled, the terminal is configured to perform 708 uplink scheduling to obtain uplink transmission resources.

If IN-conditions are fulfilled, the terminal is configured to disable uplink transmissions in step 710 and suspend uplink user plane in step 712.

If uplink transmission on U-plane is currently suspended, so-called OUT- conditions are tested in step 714. This is described in more detail in FIG. 9.

If OUT-conditions are not fulfilled, the terminal is configured to continue suspending uplink user plane in step 716.

If OUT-conditions are fulfilled, the terminal is configured to enable uplink transmissions in step 718 and perform 720 uplink scheduling to obtain uplink transmission resources.

In an embodiment, the IN and OUT-conditions utilise two pathloss thresholds, Threshold 1 and Threshold 2 and two counter thresholds, ULCountThr1 and ULCountThr2. Further, three counters are utilised, namely T-Suspend, Counter1 and Counter2.

The IN-conditions 706 test is illustrated in FIG. 8.

In step 800, the terminal device is configured to compare estimated pathloss to a Threshold1.

If the pathloss is smaller than Threshold1, counters Counter1 and Counter2 are reset to zero in step 802 and the terminal device transmits 804 uplink scheduling request to obtain uplink transmission resources.

If the pathloss is not smaller than Threshold1, Counter1 is incremented and compared to a threshold ULCountThr1 in step 806.

If Counter1 is not greater than threshold ULCountThr1, the terminal device performs 804 uplink scheduling to obtain uplink transmission resources.

If Counter1 is greater than threshold ULCountThr1, the terminal device is configured to disable uplink transmissions in step 808 reset counters Counter1 and Counter2 are reset to zero instep 810 and suspend uplink user plane in step 812.

The OUT-conditions 714 test is illustrated in FIG. 9.

In step 900, the terminal device is configured to determine whether a counter T_Suspend has expired. If the counter has expired, the terminal device is configured to enable uplink transmissions in step 902, reset counters Counter1 and Counter2 to zero in step 904 and perform 906 uplink scheduling to obtain uplink transmission resources.

If the counter was not expired, the terminal device is configured, in step 908, to compare estimated pathloss to a Threshold2.

If the pathloss is greater than Threshold2, counters Counter1 and Counter2 are reset to zero in step 910 and the terminal device suspends uplink user plane in step 912.

If the pathloss is not greater than Threshold2, Counter2 is incremented and compared to a threshold ULCountThr2 in step 914.

If Counter2 is not greater than threshold ULCountThr2, the terminal device is configured to suspend uplink user plane in step 912.

If Counter2 is greater than threshold ULCountThr2, the terminal device is configured to enable uplink transmissions in step 902, reset counters Counter1 and Counter2 to zero in step 904 and perform 906 uplink scheduling to obtain uplink transmission resources.

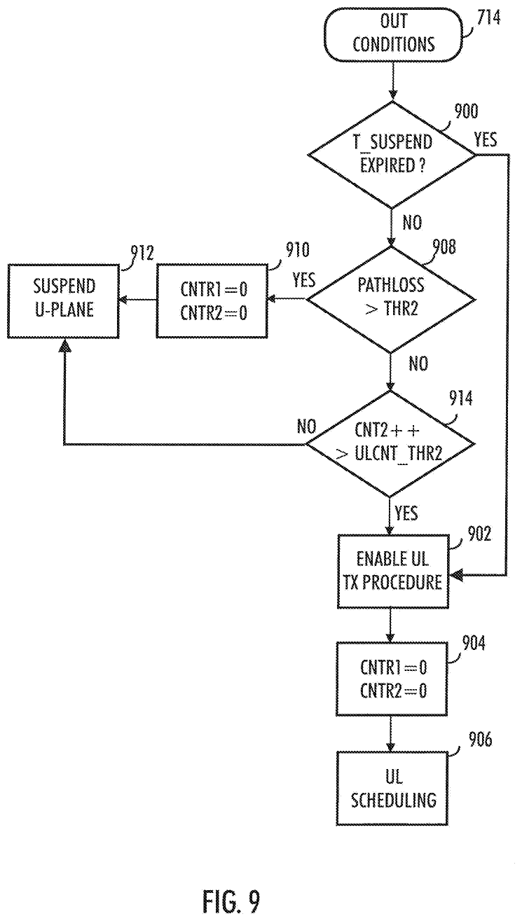

FIG. 10 illustrates thresholds Threshold 1 and Threshold 2.

In an embodiment, the Threshold1 1000 could be defined to be lower than the maximum possible limit e.g. to make a hysteresis as shown in FIG. 10, or to leave the C-plane (more robust to link loss) uplink traffic enabled and disable only the user plane traffic.

In an embodiment, the Threshold2 1002 could be lower than Threshold1 as to keep the link loss conditions checks going for getting the device to operation “In-conditions” when potentially possible.

In an embodiment, an example of the way to perform calculations to determine the pathloss to be used in the evaluation of the link estimation as depicted in the flowcharts above, is illustrated below. It may be noted that also other methods may be utilised.

First, the terminal device may determine own location and the location of the satellite node.

Then distance d to the satellite node is calculated.

Next, the frequency f at which the system operates is determined.

The free space loss between the terminal device and the satellite node may be calculated utilising following equation:

$$Free Space Pathloss = 20 \cdot {log}_{10} ( d ) + 20 \cdot {log}_{10} ( f ) + 20 \cdot {log}_{10} ( \frac{4 π}{c} )$$

where c is the speed of light.

The uplink transmission power received at the satellite may be calculated utilising following equation:

UL power at satellite=P_{MAX}+G_{TX_Device}+G_{RX_SAT}−Free Space Pathloss

where P_{MAX} is the maximum transmission output power of terminal device, G_{TX_Device} is the terminal device antenna gain and G_{RX_SAT} is the satellite antenna gain (which can be provided by the system, or be a fixed estimate).

In an embodiment, the calculation of uplink transmission power received at the satellite can be used by the terminal device in the condition-checks of Pathloss <Threshold1 or Threshold2 to determine what state to choose. The condition check may include sensitivity level information from the network, or device estimates of gNB sensitivity based on internal calculations. When using internal calculations for gNB sensitivity, the Thresholds (Threshold1 and Threshold2) may include margins and tolerances of the sensitivity estimation of the gNB.

FIG. 11 illustrates an example of passing of a satellite node over a terminal device, the satellite having the altitude of 600 km. On x-axis is distance in kilometres between a terminal device and a satellite node and on y-axis is the pathloss in dB, at frequency 2 GHz. The figure also illustrates thresholds Threshold1 and Threshold2.

When the satellite node emerges from the left the distance also thus also the pathloss between the node and the terminal device is large. The terminal device is configured to suspend uplink user plane 1100. In the flowchart of FIG. 7, OUT-conditions are applied. As the satellite node gets nearer the terminal device is at some point configured to enable uplink transmission and perform uplink scheduling 1102. In the flowchart of FIG. 7, IN-conditions are applied. After the satellite node has passed and the distance and pathloss increase, the terminal device again suspends 1104 uplink user plane. In the flowchart of FIG. 7, OUT-conditions are applied.

In the conditional process of being in- and out of Suspended UL mode, there are other methods that can be applied.

For example, statistical data on ephemeris including satellite approach or descent may be utilised. Uplink negative-acknowledges, NACK, can be used as threshold checking counting a given amount of NACK or ACK as indications before entering in/out condition. In addition, transmit power control instructions may be used as a condition for threshold check similar to the NACK, where counting the transmit power control instructions in boundary states would indicate if the satellite node is within or out of reach.

The proposed solution has multiple advantages. The power consumption of terminal devices may be reduced when the terminal devices do not try to transmit to an out of reach satellite node.

In an embodiment, a terminal device may indication to user if link quality of user plane in uplink is affected compared to downlink.

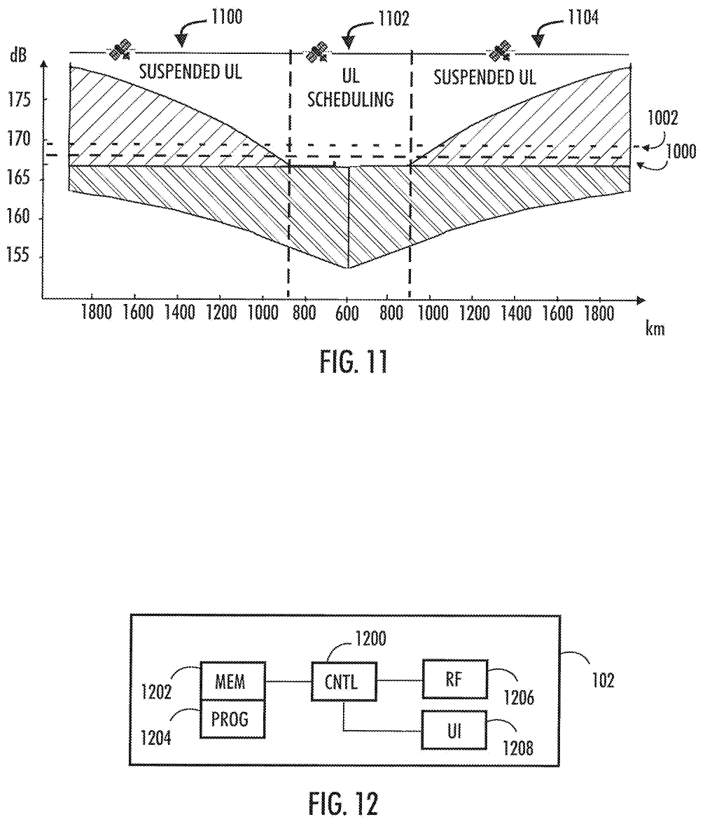

FIG. 12 illustrates an embodiment. The figure illustrates a simplified example of an apparatus applying embodiments of the invention. In some embodiments, the apparatus may be a terminal device 102, or a part of a terminal device.

It should be understood that the apparatus is depicted herein as an example illustrating some embodiments. It is apparent to a person skilled in the art that the apparatus may also comprise other functions and/or structures and not all described functions and structures are required. Although the apparatus has been depicted as one entity, different modules and memory may be implemented in one or more physical or logical entities.

The apparatus 102 of the example includes a control circuitry 1200 configured to control at least part of the operation of the apparatus.

The apparatus may comprise a memory 1202 for storing data. Furthermore, the memory may store software 1204 executable by the control circuitry 1200. The memory may be integrated in the control circuitry.

The apparatus may comprise one or more interface circuitries 1206, 1208. The interface circuitries are operationally connected to the control circuitry 1200. An interface circuitry 1206 may be a set of transceivers configured to communicate with a RAN node, such as an (e/g)NodeB of a wireless communication network or a satellite node. The interface circuitry may be connected to an antenna arrangement (not shown). The apparatus may also comprise a connection to a transmitter instead of a transceiver. The apparatus may further comprise a user interface 1208.

In an embodiment, the software 1204 may comprise a computer program comprising program code means adapted to cause the control circuitry 1200 of the apparatus to realise at least some of the embodiments described above.

The steps and related functions described in the above and attached figures are in no absolute chronological order, and some of the steps may be performed simultaneously or in an order differing from the given one. Other functions can also be executed between the steps or within the steps. Some of the steps can also be left out or replaced with a corresponding step.

The apparatuses or controllers able to perform the above-described steps may be implemented as an electronic digital computer, processing system or a circuitry which may comprise a working memory (random access memory, RAM), a central processing unit (CPU), and a system clock. The CPU may comprise a set of registers, an arithmetic logic unit, and a controller. The processing system, controller or the circuitry is controlled by a sequence of program instructions transferred to the CPU from the RAM. The controller may contain a number of microinstructions for basic operations. The implementation of microinstructions may vary depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst several computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, an apparatus comprises means for receiving downlink transmission from a satellite node; estimating pathloss of uplink transmission to the satellite node; determining based on the path loss whether uplink transmission of the apparatus can reach the satellite node; and suspending uplink transmission if determination indicates that the transmission will not reach the node

It will be obvious to a person skilled in the art that, as the technology advances, the inventive concept can be implemented in various ways. The invention and its embodiments are not limited to the examples described above but may vary within the scope of the claims.

1-15. (canceled)

16. An apparatus comprising:
at least one processor; and
at least one memory including computer program code which, when executed by the at least one processor, causes the apparatus at least to:
receive downlink transmission from a satellite node;
estimate pathloss of uplink transmission to the satellite node;
determine based on the estimated path loss whether uplink transmission of the apparatus can reach the satellite node; and
suspend uplink transmission in response to a determination that the transmission cannot reach the node.

17. The apparatus of claim 16, further configured to:
suspend user-plane uplink transmission and allow control-plane uplink transmission.

18. The apparatus of claim 16, further configured to:
determine whether uplink transmission of the apparatus can reach the satellite node by comparing the estimated path loss to a threshold.

19. The apparatus of claim 16, further configured to:
determine whether uplink transmission of the apparatus can reach the satellite node based at least partly on one or more of:
antenna gain and power class of the apparatus;
distance to the satellite node;
transmission power of the satellite node;
measured power of satellite node transmission; or
frequency offset between downlink and uplink frequencies.

20. The apparatus of claim 16, further configured to:
initiate a counter in response to uplink transmission being suspended; and
enable uplink transmission in response to the counter reaching a threshold.

21. The apparatus of claim 16, further configured to, while uplink transmission is allowed:
compare pathloss to a first threshold;
in response to the pathloss being below the first threshold, continue allowing uplink transmission;
in response to the pathloss not being below the first threshold, increase a first counter; and
suspend uplink transmission in response to the counter having expired.

22. The apparatus of claim 16, further configured to:
compare pathloss to a second threshold;
in response to the pathloss being greater than the second threshold, continue suspending uplink transmission;
in response to the pathloss not being greater than the second threshold increase a second counter; and
discontinue suspending uplink transmission in response to the counter having expired.

23. A method comprising:
receiving downlink transmission from a satellite node;
estimating pathloss of uplink transmission to the satellite node;
determining based on the path loss whether uplink transmission of the apparatus can reach the satellite node; and
suspending uplink transmission in response to a determination that the transmission cannot reach the node.

24. The method of claim 23, further comprising: suspending user-plane uplink transmission and allowing control-plane uplink transmission.

25. The method of claim 23, further comprising:
determining whether uplink transmission of the apparatus can reach the satellite node by comparing the estimated path loss to a threshold.

26. The method of preceding claim 23, further comprising:
determining whether uplink transmission of the apparatus can reach the satellite node based at least partly on one or more of:
antenna gain and power class of the apparatus;
distance to the satellite node;
transmission power of the satellite node;
measured power of satellite node transmission; or
frequency offset between downlink and uplink frequencies.

27. The method of claim 23, further comprising:
initiating a counter in response to uplink transmission being suspended; and
enabling uplink transmission in response to the counter reaching a threshold.

28. The method of claim 23, further comprising, while uplink transmission is allowed:
comparing pathloss to a first threshold and continue allowing uplink transmission in response to the pathloss being below the first threshold;
increasing a first counter, in response to the pathloss not being below the first threshold; and
suspending uplink transmission in response to the counter having expired.

29. The method of claim 23, further comprising, while uplink is being suspended:
comparing pathloss to a second threshold and continue suspending uplink transmission in response to the pathloss being greater than the second threshold; and
increasing a second counter in response to the pathloss not being greater than the second threshold; and
discontinuing suspending uplink transmission in response to the counter having expired.

30. A computer program comprising instructions for causing an apparatus to at least perform:
receiving downlink transmission from a satellite node;
estimating pathloss of uplink transmission to the satellite node;
determining based on the path loss whether uplink transmission of the apparatus can reach the satellite node; and
suspending uplink transmission in response to a determination that the transmission cannot reach the node.
